(19) United States
(12) Patent Application Publication
(10) Pub. No.: US 2012/0072283 A1
(43) Pub. Date: Mar. 22, 2012

(54) MOBILE APPLICATION RECOMMENDATION SYSTEM AND METHOD

(75) Inventors: Chris DeVore, Seattle, WA (US); Ian Sefferman, Los Angeles, CA (US); Brett Nakashima, Seattle, WA (US)

(73) Assignee: MOBILMEME, INC., Seattle, WA (US)

(21) Appl. No.: 13/232,331

(22) Filed: Sep. 14, 2011

Related U.S. Application Data
(60) Provisional application No. 61/383,532, filed on Sep. 16, 2010.

(51) Int. Cl. G06Q 30/00

(52) U.S. Cl. 705/14.49

(57) ABSTRACT

Provided herein are systems and methods for providing application recommendations.

### CROSS-REFERENCE TO RELATED APPLICATIONS

This application claims the benefit of priority to U.S. Provisional Application No. 61/383,532, filed Sep. 16, 2010, titled “MOBILE APPLICATION RECOMMENDATION SYSTEM AND METHOD,” having Attorney Docket No. MOBI-2010002, and naming inventors Chris DeVore, Ian Sefferman, and Brett Nakashima. The above-cited application is incorporated herein by reference in its entirety, for all purposes

### FIELD

The present disclosure relates to computing, and more particularly, to systems and methods for recommending applications to mobile device users.

### BACKGROUND

Many smartphones and other mobile computing devices offer a compelling platform for application developers. Applications stores for various smartphones may offer thousands, or even hundreds of thousands in some cases, of applications created by third-party developers. For example, the App Store, provided by Apple Inc. of Cupertino Calif., offers over a quarter of a million applications available for iPhone, iPod Touch, iPad, and other iOS devices as of September 2010, just over two years after the App Store's launch. Similarly, the Android Market, provided by Google Inc. of Menlo Park Calif., offers over 100,000 applications for Android devices as of August 2010. Both application marketplaces are growing rapidly, with thousands of new applications becoming available each month. Many other computing platforms offer similar application marketplaces.

With so many applications to choose from, users of iOS devices, Android devices, and other application-oriented mobile computing devices may have difficulty in discovering applications that may be of interest.

### BRIEF DESCRIPTION OF THE DRAWINGS

FIG. 1 illustrates an exemplary application recommendation system in accordance with one embodiment.

FIG. 2 illustrates several components of an exemplary recommendations server 200 in accordance with one embodiment.

FIG. 3 illustrates several components of an exemplary mobile application device in accordance with one embodiment.

FIG. 4 illustrates an exemplary series of communications between various devices in accordance with one embodiment.

FIG. 5 illustrates an application recommendation routine in accordance with one embodiment.

FIG. 6 illustrates a user-application data collection subroutine in accordance with one embodiment.

FIG. 7 illustrates an “ambient” application-related data collection subroutine in accordance with one embodiment.

FIG. 8 illustrates an overview of data that may comprise a user-application list and an application-mention list in accordance with one embodiment.

FIG. 9 illustrates an application similarity-classification subroutine in accordance with one embodiment.

FIG. 10 illustrates a subroutine for generating a list of one or more recommended applications for a requesting user in accordance with one embodiment.

FIGS. 11-15 illustrate an exemplary application-recommendation application displaying various information on a mobile application device in accordance with various embodiments.

FIG. 16 illustrates a mention-tracking widget embedded on a web page displayed in a web browser in accordance with one embodiment.

### DESCRIPTION

In accordance with various embodiments, an application discovery service may provide consumers with application recommendations based on a variety of vectors. Some of these vectors include the “hottest” applications currently being talked about on the web, applications that a user has previously indicated that he or she enjoys, and applications a user's friends have indicated that they enjoy, and the like.

One commercial embodiment of such an application discovery service is AppStoreHQ (http://www.appstorehq.com), which ingests data from several sources to determine current applications that a user is likely to be interested in. At the present time, the AppStoreHQ embodiment utilizes the K-Nearest Neighbor (KNN) algorithm combined with one or more “boost” factors. For example, the current AppStoreHQ embodiment matches content from around the web (e.g., blogs, news sites, Twitter, and the like) to mobile applications, using such information to “boost” applications that are currently being discussed the most (the “hottest” apps).

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file servers, computer servers, and/or memory storage devices. Each of these conventional distributed computing components is accessible by the processor via a communication network.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

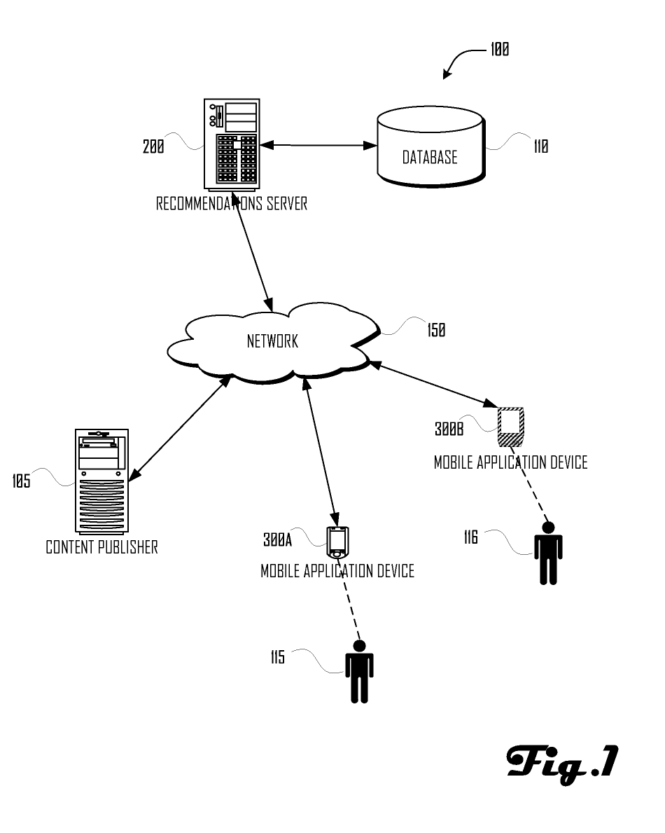

FIG. 1 illustrates an exemplary application recommendation system 100 in accordance with one embodiment. In application recommendation system 100, recommendations server 200 collects data from several mobile application devices 300A-B (operated by users 115-116, respectively), as well as content publisher 105 via network 150. Collected data is stored in database 110. In some embodiments, database 110 may also store other information related to user accounts and/or devices. In some embodiments, recommendations server 200 may communicate with database 110 via network 150, a storage area network (“SAN”), a high-speed serial bus, and/or via other suitable communication technology.

In some embodiments, other servers and/or devices (not shown) may also be present. For example, in many embodiments, multiple additional mobile application devices and/or non-mobile application devices may be present. Similarly, in many embodiments, multiple content publishers may also be present. In some embodiments, one or more intermediary application servers and/or platform-provider servers may also be present.

In some embodiments, recommendations server 200 and/or database 110 may comprise one or more replicated and/or distributed physical or logical devices. In various embodiments, network 150 may include the Internet, a local area network (“LAN”), a wide area network (“WAN”), a cellular data network, and/or other data network.

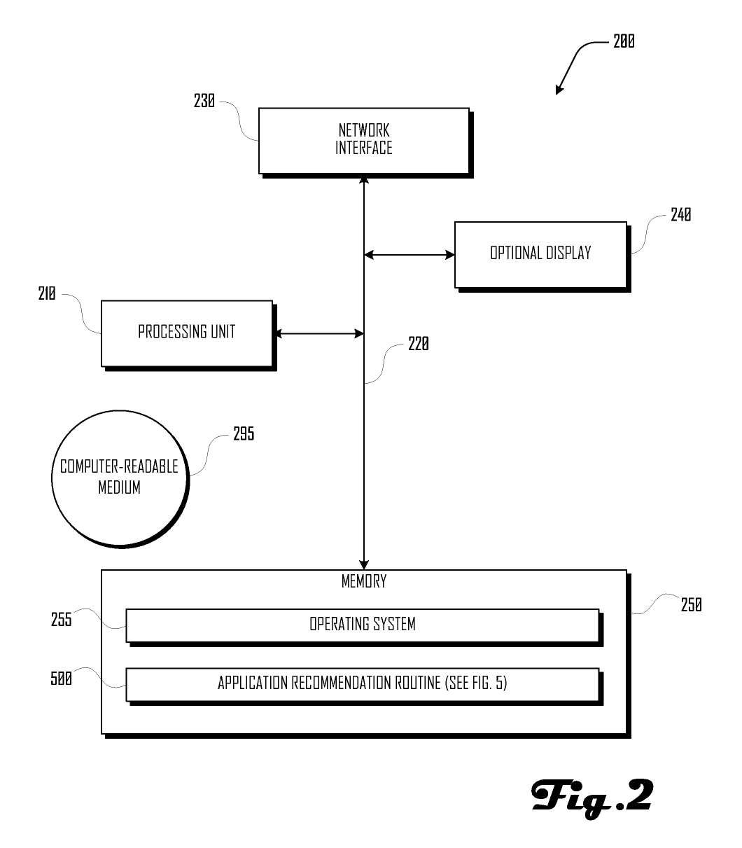

FIG. 2 illustrates several components of an exemplary recommendations server 200 in accordance with one embodiment. In some embodiments, recommendations server 200 may include many more components than those shown in FIG. 2. However, it is not necessary that all of these generally conventional components be shown in order to disclose an illustrative embodiment. As shown in FIG. 2, recommendations server 200 includes a network interface 230 for connecting to the network 150.

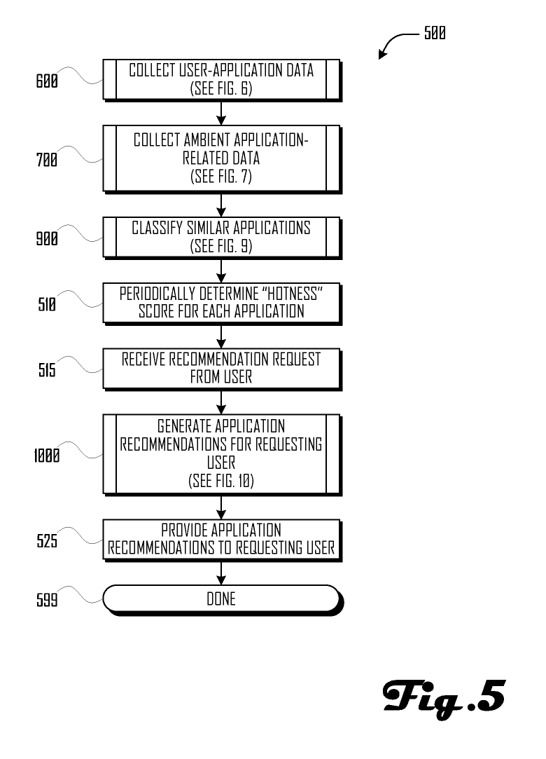

Recommendations server 200 also includes a processing unit 210, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for an application recommendation routine 500 (see FIG. 5, discussed below). In addition, the memory 250 also stores an operating system 255. These and other such software components may be loaded from a computer readable storage medium 295 into memory 250 of the recommendations server 200 using a drive mechanism (not shown) associated with a non-transient computer readable storage medium 295, such as a floppy disc, tape, DVD/CD-ROM drive, memory card, or the like. In some embodiments, software components may also be loaded via the network interface 230, rather than via a computer readable storage medium 295.

Notification server 200 also communicates via bus 220 with database 110. In various embodiments, bus 220 may comprise a storage area network (“SAN”), a high-speed serial bus, and/or via other suitable communication technology. In some embodiments, recommendations server 200 may communicate with database 110 via network interface 230.

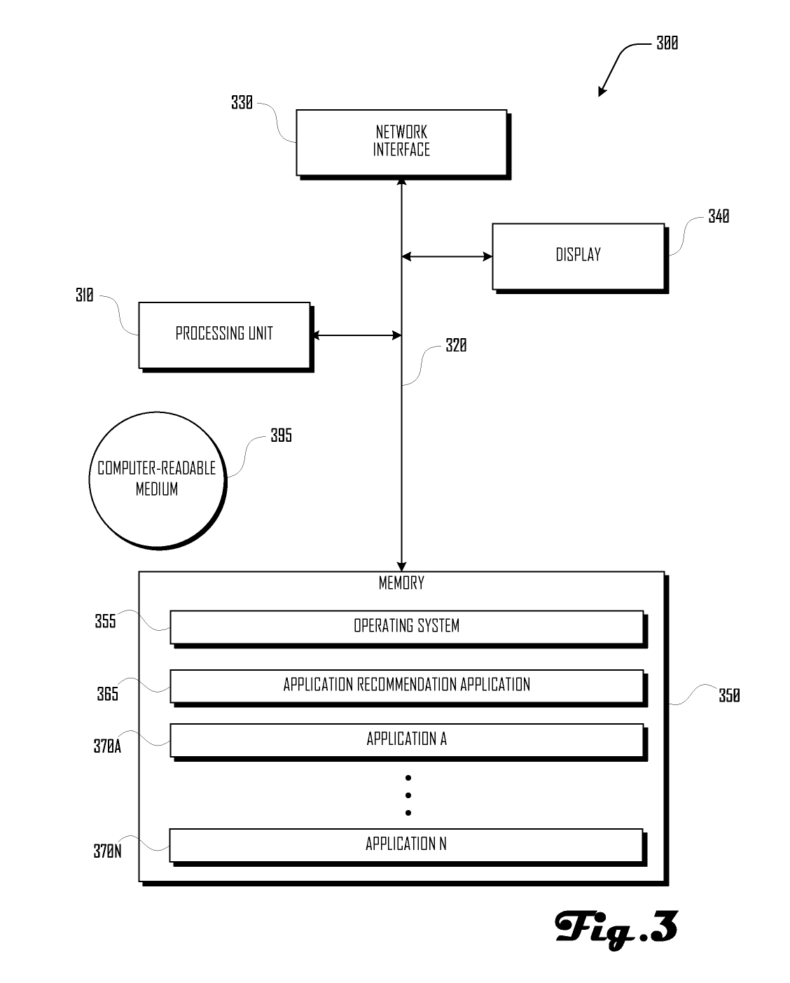

FIG. 3 illustrates several components of an exemplary mobile application device 300 in accordance with one embodiment. In some embodiments, mobile application device 300 may include many more components than those shown in FIG. 3. However, it is not necessary that all of these generally conventional components be shown in order to disclose an illustrative embodiment. As shown in FIG. 3, the mobile application device 300 includes a network interface 330 for connecting to the network 150.

The mobile application device 300 also includes a processing unit 310, a memory 350, and a display interface 340, all interconnected along with the network interface 330 via a bus 320. The memory 350 generally comprises a random access memory (“RAM”), a read only memory (“ROM”), and a permanent mass storage device, such as a disk drive, flash device, or the like. The memory 350 stores program code for an application-recommendation application 365, and several additional applications 370A-N. In addition, the memory 350 also stores an operating system 355. These software components may be loaded from a computer readable storage medium 395 into memory 350 of the mobile application device 300 using a read mechanism (not shown) associated with a non-transient computer readable storage medium 395, such as a floppy disc, tape, DVD/CD-ROM drive, memory card, or the like. In some embodiments, software components may also be loaded via the network interface 330, rather than via a computer readable storage medium 395.

Although an exemplary mobile application device 300 has been described that generally conforms to conventional general purpose computing devices, a mobile application device 300 may be any of a great number of mobile devices capable of communicating with the network 150 and obtaining applications, for example, a personal game console, a handheld computer, a cell phone, or any other suitable mobile device. In some embodiments, some or all of the systems and methods disclosed herein may also be applicable to non-mobile devices, such as a personal computer, a set-top box, and the like.

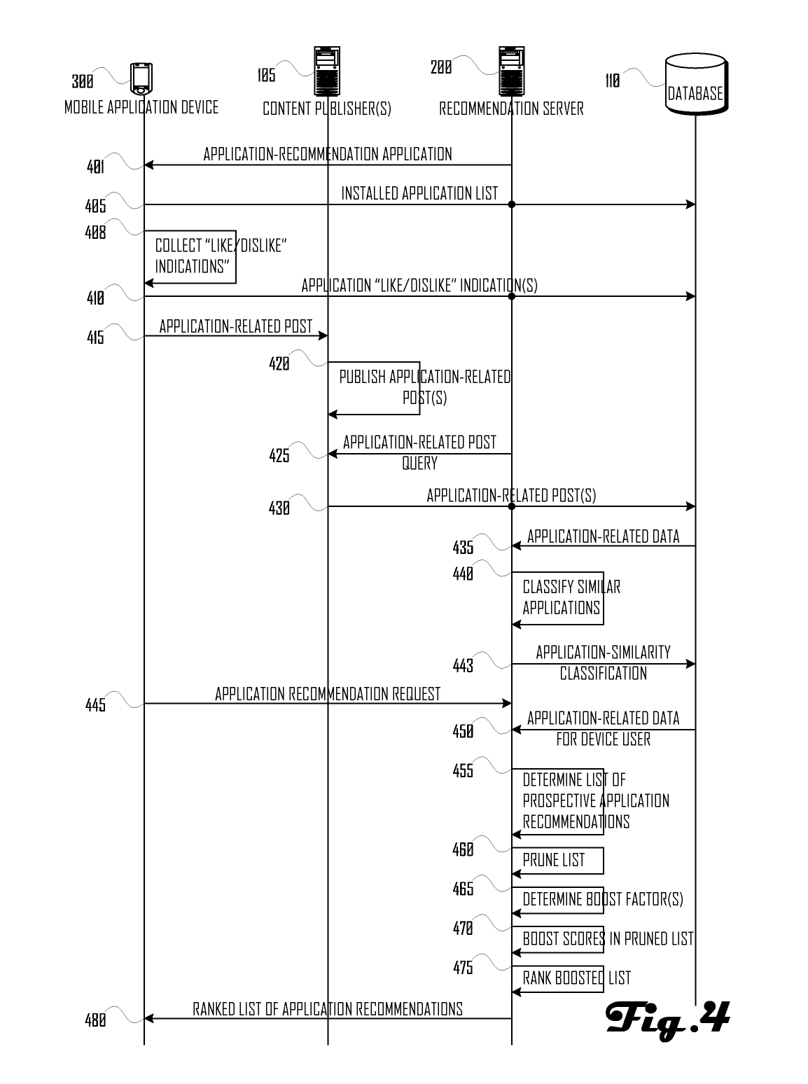

FIG. 4 illustrates an exemplary series of communications between mobile application device 300, content publisher 105, recommendations server 200, and database 110, in accordance with one embodiment. The illustrated series of communications shows an exemplary scenario in which recommendations server 200 collects application-related data and provides an application recommendation to mobile application device 300.

Beginning the illustrated sequence of operations, mobile application device 300 obtains an application-recommendation application 401 via recommendations server 200. In some embodiments, mobile application device 300 may obtain the application-recommendation application directly from recommendations server 200. In other embodiments, obtaining applications may involve one or more additional servers (not shown), such as an application store server, a platform-provider server, and the like.

Once installed on mobile application device 300, application-recommendation application provides a list 405 of applications that are installed on mobile application device 300, which associates the list in database 110 with a user of mobile application device 300. In some embodiments, the list 405 may be a complete list of all applications. In other embodiments, the list 405 may be pruned to omit common applications that may be installed on all devices of a certain type.

In addition, application-recommendation application may provide a user interface or other facility to collect “like” and/or “dislike” indications 408 from the user of mobile application device 300 about one or more applications. In various embodiments, the “like” and/or “dislike” indications 408 may include indications corresponding to some or all of the applications in the list 405, as well as some number of not-currently-installed applications.

Mobile application device 300 sends the collected “like” and/or “dislike” indications 410 to recommendations server 200, which associates them with the mobile application device user in database 110. In other embodiments, recommendations server 200 may provide a web-based user interface and/or an Application Programming Interface (“API”) for collecting information such as applications that are installed on mobile application device 300, as well as “like” and/or “dislike” indications.

In some embodiments, the user may also use mobile application device 300 to send one or more application-related posts 415 to one or more content publisher(s) 105, which publishes 420 the application-related post. For example, in one embodiment, the user may use mobile application device 300 to publish a blog post about an application via a blogging service and/or to publish a microblog post about an application via a microblogging service. In another embodiment, the user may use mobile application device 300 to publish an application-related status update message via a social networking service. In other embodiments, the user may publish other types of application related “posts” or content items via other publishing services. In some embodiments, the user may additionally publish one or more application-related posts via another computing device (not shown).

In some embodiments, recommendations server 200 may periodically monitor a number of content publisher(s) 105, sending a query 425 for application-related posts to content publisher(s) 105. Responding to the query, content publisher(s) 105 send one or more application-related posts 430 to recommendations server 200, which ingests the data (as discussed below) into database 110.

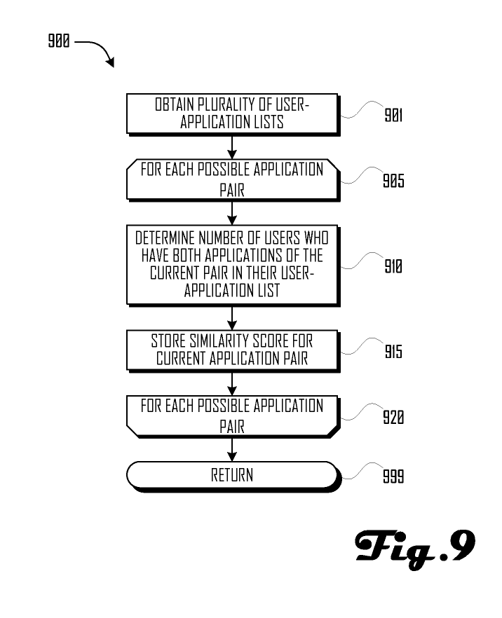

Periodically or on-demand, recommendations server 200 retrieves application-related data 435 it has stored in database 110 and processes the data to classify 440 similar applications (see FIG. 9, discussed below). For example, in one embodiment, recommendations server 200 may fill out an adjacency matrix where each entry is how many users two applications have in common (in one embodiment, two applications may be said to have a user in common if both applications have been installed, “liked,” mentioned in a published post, or the like, by two different users). Recommendations server 200 stores the similarity-classification information thereby derived in database 110.

At some point, recommendations server 200 receives a request 445 for one or more application recommendations from mobile application device 300. For example, in one embodiment, the user may request recommendations via a user interface provided by application-recommendation application. In other embodiments, user may request recommendations via a web-based user interface or API provided by recommendations server 200. In still other embodiments, recommendations server 200 may periodically or at certain times automatically generate and push one or more recommendations to the user. Recommendations server 200 retrieves application-related data 450 pertinent to the requesting user. For example, in one embodiment, recommendations server 200 may retrieve one or more lists of applications that the user has installed, “liked,” and/or mentioned in a published post.

Using such data, recommendations server 200 determines a list 455 of prospective application recommendations. For example, in one embodiment, recommendations server 200 may determine a list of prospective recommended applications that are deemed to be similar to applications that the user has installed, “liked,” and/or mentioned in a published post, each of the prospective applications having a similarity score derived when the applications were classified (440).

Recommendations server 200 prunes the list of prospective recommendations 460, removing applications that may not be suitable to recommend for some reason. For example, in one embodiment, a prospective recommendation may be pruned because the user already has the prospective recommendation installed or because the user has previously indicated that he or she does not “like” or is otherwise disinterested in the prospective application.

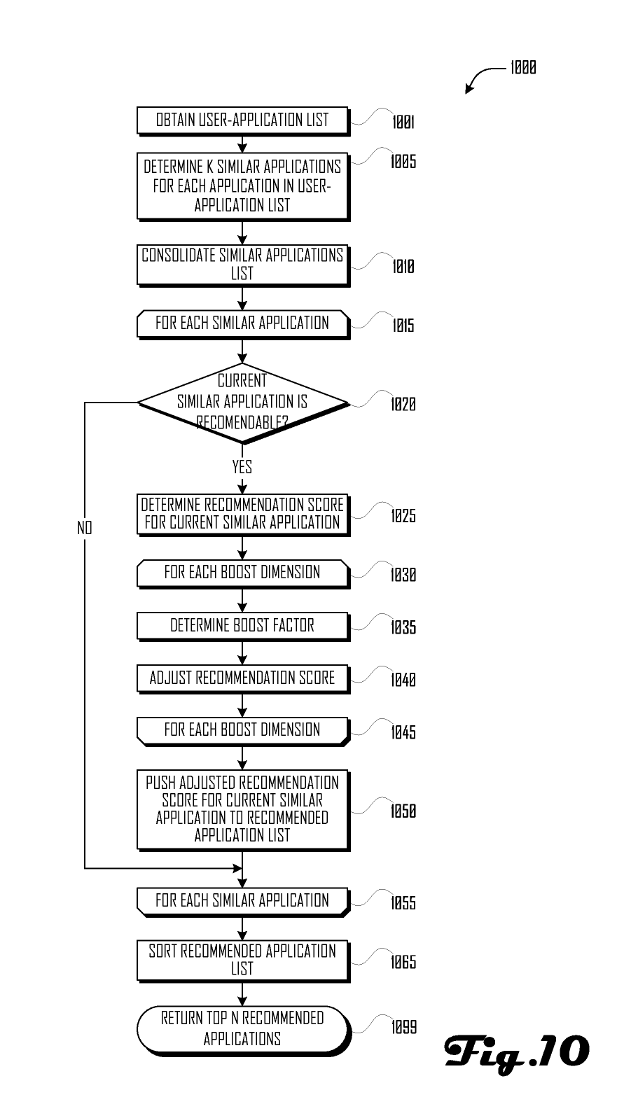

Recommendations server 200 determines one or more “boost” factors 465 to adjust the pruned list of prospective recommendations. For example, in one embodiment, recommendations server 200 may determine to boost prospective recommendations according to a “currentness” or “hotness” factor and/or a “personalization” factor. (See FIG. 10, discussed below, for a more detailed discussion of boost factors.)

Using the determined boost factors, recommendations server 200 boosts 470 appropriate scores in the pruned list of prospective applications before ranking 475 the boosted list. Finally, recommendations server 200 sends some or all of the ranked list of application recommendations to mobile application device 300 for display to the user (e.g., via application-recommendation application).

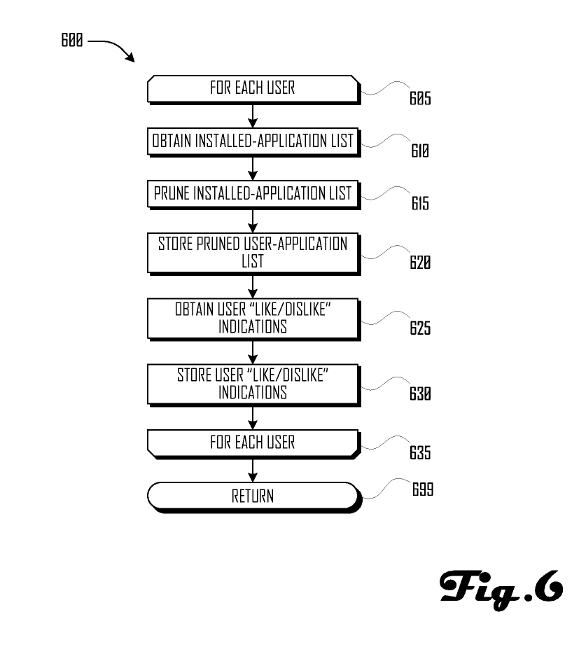

FIG. 5 illustrates an application recommendation routine 500, such as may be performed by recommendations server 200 in accordance with one embodiment. Beginning in subroutine block 600 (see FIG. 6, discussed immediately below), routine 500 collects user-application data (data related to applications that have been installed or “liked” by users who are registered with or otherwise known to the recommendations system). In most embodiments, the collection of user-application data is on ongoing process.

FIG. 6 illustrates a user-application data collection subroutine 600 in accordance with one embodiment. In most embodiments, some or all of subroutine 600 may be performed on an ongoing basis, collecting new application installation and/or like/dislike indications as new data becomes available.

Beginning in starting loop block 605, subroutine 600 processes a plurality of users who are registered with or otherwise known to subroutine 600. In block 610, subroutine 600 obtains from a remote mobile application device a list of applications that are installed on the mobile application device operated by the current user. For example, in one embodiment, users may install an application-recommendation application that may monitor applications that are installed on their mobile application devices. In some embodiments, the application-recommendation application may be able to automatically determine which applications are installed, either by running in the background, by performing periodic scans, or the like. In such embodiments, an application-recommendation application may periodically update user-application data for a particular user. In other embodiments, the application-recommendation application may provide a user interface for the user to indicate which applications are installed on the device. In other embodiments, a user may provide information about applications that are installed on his or her mobile application device via a web-based user interface.

In block 615, subroutine 600 prunes the list of applications received in block 610 to remove applications that should not play a part in generating recommendations (e.g., common applications that may be permanently installed and/or installed by default on many or all devices of a certain type). In some embodiments, the application list may be obtained with such applications already pruned out. In some embodiments, the application list may be a partial list, including only those applications that have been installed (or removed) since a previous report for the user.

In block 620, subroutine 600 stores the pruned user-application list in association with the current user (e.g., in database 110). In some embodiments, storing the pruned user-application list may include updating an existing user-application list. In other embodiments, subroutine 600 may store (e.g., in database 110) the complete (un-pruned) list of applications received in block 610, remove applications that should not play a part in generating recommendations at the time a recommendation is generated (see FIG. 10, discussed below).

In block 625, subroutine 600 obtains one or more “like” and/or “dislike” indications for the current user. For example, in one embodiment, an application-recommendation application executing on a remote mobile application device may provide a user interface for the current user to indicate that he or she “likes” or “dislikes” (or is not interested in) one or more applications. In such applications, the application-recommendation application may provide such “like” and/or “dislike” indications to subroutine 600 as they are collected on the remote mobile application device. In other embodiments, subroutine 600 may obtain one or more “like” and/or “dislike” indications via a web interface, via an API, or via other suitable interface. In block 630, subroutine 600 stores the received “like” and/or “dislike” indications in association with the current user (e.g., in database 110).

In ending loop block 635, subroutine 600 iterates back to block 605 to process the next user (if any). Subroutine 600 ends in block 699.

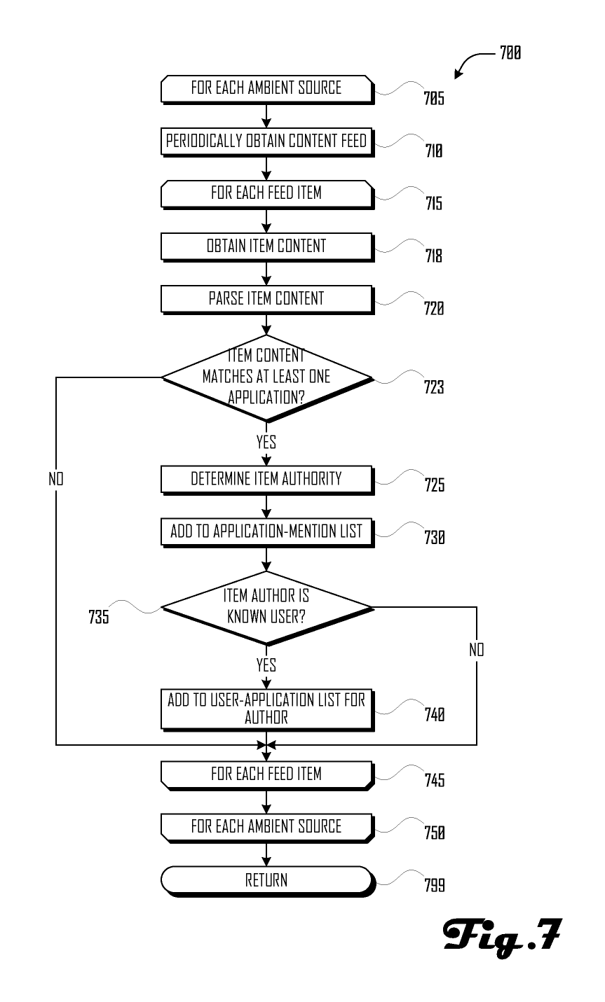

Referring again to FIG. 5, in subroutine block 700 (see FIG. 7, discussed immediately below), routine 500 collects “ambient” application-related data or data derived from published application-related postings, such as blog posts, microblog posts, status updates, and the like. In most embodiments, the collection of “ambient” application-related data is on ongoing process.

FIG. 7 illustrates an “ambient” application-related data collection subroutine 700 in accordance with one embodiment. Beginning in starting loop block 705, subroutine 700 monitors one or more content publishers or sources of “ambient” content that may be related to applications. In one embodiment, subroutine 700 may monitor one or more pre-determined web sites, blogs, microblogs, social networks, and the like. In one embodiment, such content sources may be determined based on traffic, typical post quality, genre of posts, and the like.

In block 710, subroutine 700 periodically obtains a content feed comprising one or more content items from the current ambient content source. For example, in one embodiment, subroutine 700 may subscribe to an RSS feed associated with the current ambient content source. In other embodiments, subroutine 700 may query a content source to obtain one or more content items. For example, in one embodiment, subroutine 700 may contact a content source such as Twitter multiple times a day to obtain tweets about mobile applications. In such an embodiment, subroutine 700 may monitor search feeds for various terms, such as “iTunes,” “appstorehq,” “android app,” and the like.

In other embodiments, a content source that may or may not otherwise be monitored may provide a content feed via an embeddable widget provided by a server (e.g., recommendations server 200) associated with subroutine 700. For example, in one embodiment, recommendations server 200 may provide a widget for one or more applications, the widget including an image displaying some or all of the following attributes of its application: name, icon, rating, price, category, and hottest ranking Any publishers can use such a widget to help its readers learn more about an application. When a publisher includes an URL to a widget in a post or other content item, the corresponding image may be sourced from recommendations server 200. Because the widget URL identifies recommendations server 200 as the source of the widget, recommendations server 200 (and thus subroutine 700) may be able to track and obtain content items that include the widget.

Beginning in starting loop block 715, subroutine 700 processes each feed item obtained in block 710. In block 718, subroutine 700 obtains content corresponding to the current feed item. For example, in one embodiment, subroutine 700 may request and receive the full text of an article, blog post, microblog post, status update, or the like indicated by the current feed item.

In block 720, subroutine 700 parses the current item content, seeking an identifier of a mobile application. In some embodiments, the identifier sought may be a unique identifier. For example, an identifier of an Android mobile application may include a package name and/or a link to one of several sites that can be mapped to a particular application. For another example, an identifier of an iOS mobile application may include a link to the App Store. In one embodiment, when parsing the content of the current item, subroutine 700 looks for links. If the current item content includes one or more links, subroutine 700 may determine whether any of the links identify a mobile application. If not, subroutine 700 may follow one or more of the links (including any various redirects due to URL shorteners, affiliate links, and the like) and look for application identifying links in the content of the destination page.

In decision block 723, subroutine 700 determines whether the current item content includes (or refers to) an identifier of a mobile application. If not, then subroutine 700 skips to ending look block 745 to process the next content item (if any).

However, if subroutine 700 determines that the current item content includes (or refers to) an identifier of a mobile application, then in block 725, subroutine 700 determines an authority metric associated with the current item. In various embodiments, the authority metric may be determined based at least in part on one or more API-accessible, externally-maintained site and/or page rankings, such as an Alexa score (provided by Alexa Internet, Inc. of San Francisco Calif.), a Compete rank (provided by Compete.com of Boston Mass.), a PageRank (provided by Google Inc. of Menlo Park Calif.), a mozRank (provided by SEOmoz, Inc. of Seattle Wash.), and the like. In other embodiments, an item's authority metric may be determined based at least in part on the author's “friend” and/or “follower” counts, e.g., on a social networking and/or microblogging service. In some embodiments, determining an authority metric may also include determining whether the item's author appears to be an automated software process or “bot,” determining whether the post and/or content source appears to be intended solely to manipulate application rankings or is otherwise “spammy.”

For example, in one embodiment, an authority metric for a blog or other website post may be determined by retrieving Alexa and Compete scores for the domain from which the content item was posted. In one embodiment, the Alexa and Compete scores are used as follows to determine the authoritativeness of the domain:

raw_alexa_score = download_alexa_score( ) | |
DEFAULT_ALEXA_SCORE
raw_compete_score = download_compete_score( ) | |
DEFAULT_COMPETE_SCORE
def normalize_score(score)

return 150 + (−75 * arctan(0.0002 * (score − 10000)))

end
alexa = normalize_score(raw_alexa_score)
compete = normalize_score(raw_compete_score)
authority_score = ((alexa + compete) / 2.0).ceil

In another embodiment, an authority metric for a microblog post or a social network status update may be determined by retrieving the author's friend and follower counts and computing an authority score as follows:

return 0.0 if bot? # author does not appear to be human
num_followers = download_num_followers( )
num_friends = download_num_friends( )
return 0.0 if num_followers < MIN_FOLLOWERS | | num_friends <
MIN_FRIENDS
return 0.0 if num_friends > SPAM_FF_RATIO_THRESHOLD *
num_followers
return 0.0 if num_friends == 0.0 | | num_followers == 0.0
ff_ratio = num_followers / num_friends
score = 0.33 * ((num_followers / 10.0) ** 0.5) * ff_ratio * 10.0
return MAX_SCORE if score > MAX_SCORE
return score

In other embodiments, other authority metrics may also be employed. Once subroutine 700 has determined an authority metric for the current content item, in block 730, an application-mention list for the mobile application identified in the current content item is updated according to the current content item and authority metric (e.g., in database 110). In various embodiments, the application-mention list for a given application may track public mentions of that application via content sources monitored by subroutine 700. In some embodiments, application-mention lists may be used to determine “hot” applications, as discussed below.

In block 735, subroutine 700 determines whether the author of the current content item is a user known to have a corresponding user-application list. If not, then subroutine 700 skips to ending look block 745 to process the next content item (if any). If, however, the author of the current content item is a user having a corresponding user-application list, then in block 740, subroutine 700 adds the mobile application identified in the current content item to the author's user-application.

In some embodiments, sentiment analysis may be used to determine whether a mention is speaking positively or negatively about an application and to weight the mention accordingly. In other embodiments, it may be assumed that most mentions about applications are positive, so mentions may be treated as a reasonable proxy for applications that a user likes.

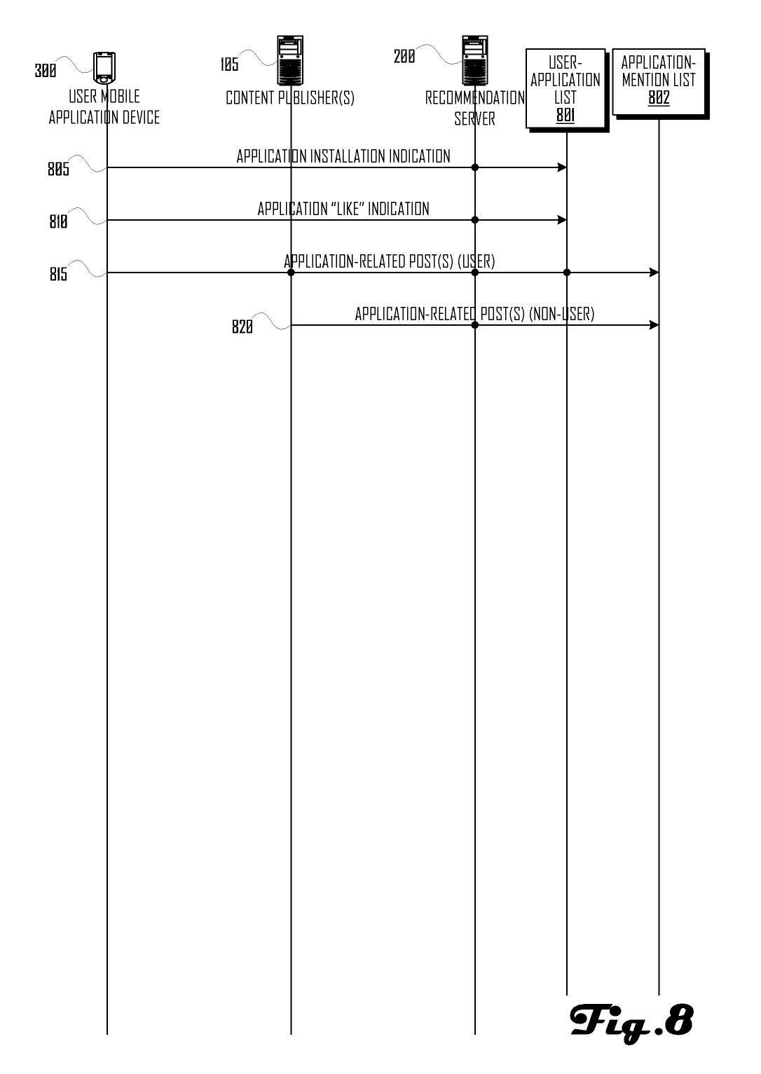

FIG. 8 illustrates an overview of data that may comprise a user-application list and an application-mention list in accordance with one embodiment. An indication 805 that a given application is installed on a user's mobile application device corresponds to an entry in that user's user-application list 801. Similarly, an indication 810 that the user “likes” a given application, in one embodiment, may also correspond to an entry in that user's user-application list 801. Content items (e.g. blog posts, microblog posts, status updates, and the like), authored by the user and published via a content publisher 105, that mention a given application may, in some embodiments, correspond not only to an entry in that user's user-application list 801, but also to an entry in the mentioned application's application-mention list. Content items (e.g. blog posts, microblog posts, status updates, and the like), authored by others, that mention a given application may, in some embodiments, correspond to an entry in the mentioned application's application-mention list.

Referring again to FIG. 7, in ending look block 745, subroutine 700 loops back to block 715 to process the next content item (if any). In ending loop block 750, subroutine 700 loops back to block 705 to process the next content item (if any). Subroutine 700 ends in block 799.

Referring again to FIG. 5, in subroutine block 900 (see FIG. 9, discussed immediately below), routine 500 processes some or all of the application-related data it has collected to classify applications according to similarity. In most embodiments, the similar application classification process takes place periodically (e.g., several times a day, to reflect newly collected application-related information) and/or on-demand (e.g., when a recommendation request is received).

FIG. 9 illustrates an application similarity-classification subroutine 900 in accordance with one embodiment. In block 901, subroutine 900 obtains (e.g. from database 110) a plurality of lists of applications that have been installed, liked, and/or mentioned by a respective plurality of users (e.g., subroutine 900 obtains user-application lists for a plurality of users).

Beginning in starting loop block 905, subroutine 900 iterates over every possible pair of applications mentioned in any of the user-application lists. For example, if user-application list for user1 includes applications [A], and user-application list for user2 includes applications [B,C], and user-application list for user3 includes applications [A,C,D], then subroutine 900 would iterate over application pairs {A,B}, {A,C}, {A,D}, {B,C},{B,D}, and {C,D}.

In block 910, subroutine 900 determines how many users have both applications of the current pair in their respective user-application lists. In block 915, the determined number is stored as a similarity score (e.g. in database 110) for the current application pair.

In ending loop block 920, subroutine 900 iterates back to block 905 to process the next pair of applications (if any). Subroutine 900 ends in block 999.

In one embodiment, subroutine 900 may be implemented as follows, using a K-Nearest Neighbor (“KNN”) algorithm to determine an adjacency matrix (held in the hash, computed_similarity_scores). This hash may be used to store the top-K neighbors in database 110.

user_ids_for_apps = { }
foreach app_user in (app_mention_users)

foreach app_id in app_user.app_ids

user_ids_for_apps[app_id].push(app_user.user_id)

end

end
computed_similarity_scores = { }
foreach app_id1 in user_ids_for_apps.keys

foreach app_id2 in user_ids_for_apps.key
if app_id1 == app_id2

computed_similarity_scores[app_id1][app_id2] = 0.0

else

score = (

user_ids_for_apps[app_id1] &
user_ids_for_apps[app_id2]

).size
computed_similarity_scores[app_id1][app_id2] = score

end

end

In block 510, a “hotness” metric may be periodically computed for the current similar application based on data in the current similar application's application-mention list. In one embodiment, each application's application-mention list is processed periodically (e.g., every few hours), and a decay score for all of the application's mentions are calculated based on the age of the mention, then summed. In some embodiments, only a portion of entries in the application-mention list may be processed (e.g., entries from the last N hours, where N is configurable). In some embodiments, each mention may be weighted according to its type (e.g., blog posts vs. microblog posts vs. status updates, and the like) and/or according to an authority of the mention's author, before being summed. The decayed, possibly weighted, summed score represents a current “hotness” score for the application, which may reflect which applications being talked about or mentioned the most at the current time.

In one embodiment, hotness scores may be calculated as follows.

app_mentions = { }
foreach post in all_mentions_in_last_n_days

foreach app in post

app_mentions[app].push(post)

end

end
hottest_scores = { }
foreach app, mentions in app_mentions

hottest_scores[app] = 0.0
foreach post in mentions

decay_score = p.author.authority_score * (0.5 + (

1.0/PI *
arctan(−1.5 * (p.age_in_days − −1.5))

))
weighted_post_score = post_type_weight(p.type) *
decay_score
hottest_scores[app] += weight_post_score

end

end
hottest_rank = sort_keys_by_value(hottest_scores)

In block 515, routine 500 receives a request from a user to provide a list of recommended applications. For example, in one embodiment, the user may request recommendations via a user interface provided by application-recommendation application. In other embodiments, a user may request recommendations via a web interface or other user interface. In some embodiments, an application-recommendation application may automatically make a proactive recommendation request on behalf of a user.

In subroutine block 1000 (see FIG. 10, discussed below), routine 500 generates a list of one or more recommended applications for the requesting user.

FIG. 10 illustrates subroutine 1000 for generating a list of one or more recommended applications for a requesting user in accordance with one embodiment. In block 1001, subroutine 1000 obtains a user-application list (e.g., from database 110) corresponding to the requesting user. In block 1005, using data stored by subroutine 900 (see FIG. 9, discussed above), subroutine 1000 determines a certain number (K) of applications that are deemed to be similar to each one of the applications in the user-application list. In one embodiment, K is equal to five, and the list of similar applications may initially include five times the number of applications in the user-application list, with each entry in the similar application list being associated with a similarity score associated with that similar application and its “seed” application (the application from the user-application list that the similar application was deemed to be similar to).

In block 1010, subroutine 1000 consolidates duplicates (if any) in the initial similar applications list. In one embodiment, consolidating duplicates may include summing the similarity scores associated with each duplicate similar application to obtain a cumulative similarity score for the consolidated entry in the similar application list.

Beginning in starting loop block 1015, subroutine 1000 processes each similar application in the consolidated similar application list. In block 1020, subroutine 1000 determines whether the current similar application is recommendable. For example, a similar application may not be recommendable if the requesting user has previously indicated that he or she dislikes or is not interested in the similar application. If the current similar application is not recommendable, then subroutine 1000 skips to ending loop block 1055, and iterates back to block 1015 to process the next similar application (if any).

If the current similar application is determined to be recommendable, then in block 1025, subroutine 1000 determines a recommendation score for the current similar application. In one embodiment, the recommendation score may be equal to or derived from the similarity score associated with the current similar application (which may be a cumulative similarity score if the current similar application was duplicated in the original similar application list).

In some embodiments, including those in which the system has a large corpus of user-application data, the base recommendation score may be a meaningful measure of how likely the user is to be interested in the current similar application. However, in some cases, including those in which the corpus of user-application data may not be large, the base recommendation score may be improved by adjusting it (or “boosting” it) according to one or more boost dimensions. For example, in one embodiment, the base recommendation scores may be boosted according to a “hotness” or “currentness” dimension and/or a “social” or “friends” dimension.

Beginning in starting loop block 1030, subroutine 1000 processes each boost dimension to be employed. In block 1035, subroutine 1000 determines a boost factor for the current boost dimension.

For example, in some embodiments, subroutine 1000 may determine a boost factor based on how “Hot” or “Current” the current similar application is determined to be according to its current hotness score (see FIG. 5 block 510, discussed above).

In one embodiment, a hotness boost factor may be determined as follows.

BOOST_SLOPE_1_20 = ( 1.25 − 1.05 ) / ( 1.0 − 20.0 )
BOOST_SLOPE_21_100 = ( 1.05 − 1.00 ) / ( 21.0 − 100.0 )
def hottest_boost( app, current_score )

rank = app.hottest_ranking
multiplier = case rank

when 1..20 then (BOOST_SLOPE_1_20 * (rank − 1)) + 1.25
when 21..100 then (BOOST_SLOPE_21_100 * (rank −
21)) +1.05
else nil
end

return current_score if multiplier.nil?
return current_score * multiplier

end

For another example, in some embodiments subroutine 1000 may integrate with a social networking service that may indicate one or more “friend” type users associated with the current user. In such embodiments, subroutine 1000 may determine a boost factor based on a social network or friendship dimension as follows.

def friends_boost(app, current_score, user)

num_friends =
calculate_number_of_friends_who_like_this_app(app, user)
multiplier = 1.0
multiplier += num_friends * 0.01
multiplier = MAX_FRIENDS_BOOST if multiplier >=
MAX_FRIENDS_BOOST
return current_score * multiplier

end

In some embodiments, such a friendship boost calculation may be enhanced by weighting the user's friends according to an authority metric such as the number of friends that two users have in common. (The more friends in common, the more likely the two users are to care about each other's application preferences.)

In other embodiments, other boost dimensions may be employed, such as application category (e.g., games, utilities, productivity, and the like), language, developer, application price, geographical location, and the like.

In block 1040, subroutine 1000 adjusts the current similar application's base recommendation score according to the currently determined boost factor. In ending loop block 1045, subroutine 1000 loops back to block 1030 to process the next boost dimension (if any).

Once the base recommendation score for the current similar application has been adjusted according to all boost factors, in block 1050, subroutine 1000 pushes the adjusted recommendation score for the current similar application onto a recommended application list. In ending loop block 1055, subroutine 1000 iterates back to block 1015 to process the next similar application (if any).

In block 1065, subroutine 1000 sorts the recommended application list according to each entry's adjusted recommendation score. In block 1099, subroutine 1000 ends, returning at least some of the sorted recommended application list to the caller.

In one embodiment, subroutine 1000 may be implemented as follows.

recs_with_scores = { }
apps = (installed_apps + liked_apps + mentioned_apps)
do_not_recommend_apps = (disliked_apps + not_interested_apps)
foreach app in apps

foreach neighbor in app.neighbors # neighbor is from our KNN build

next if apps.include?(neighbor.app) # don't rec if we already
have next if do_not_recommend_apps.include?(neighbor.app)
total_score = hottest_boost(neighbor.app, neighbor.score)
total_score = friends_boost(neighbor.app, total_score, user)
recs_with_scores[neighbor.app] += total_score

end

end
recs = recs_with_score.sort_keys_by_value

Referring again to FIG. 5, in block 525, routine 500 provides the list of recommended applications for display to the requesting user. Routine 500 ends in block 599.

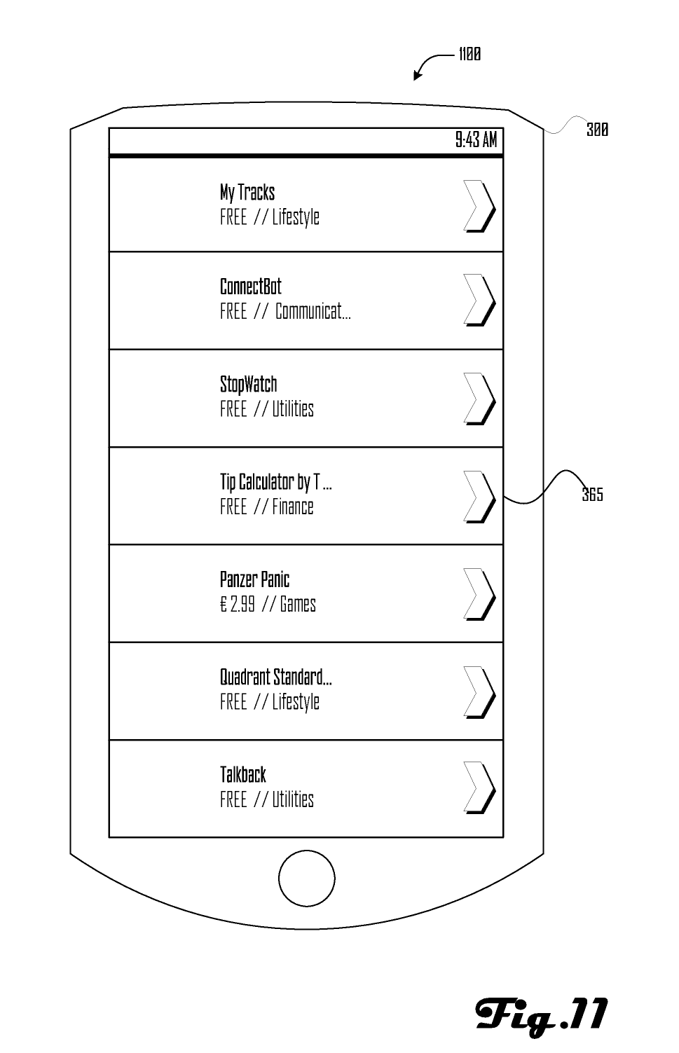

FIG. 11 illustrates an exemplary application-recommendation application 365 displaying on mobile application device 300 a list of applications installed on mobile application device 300 in accordance with one embodiment.

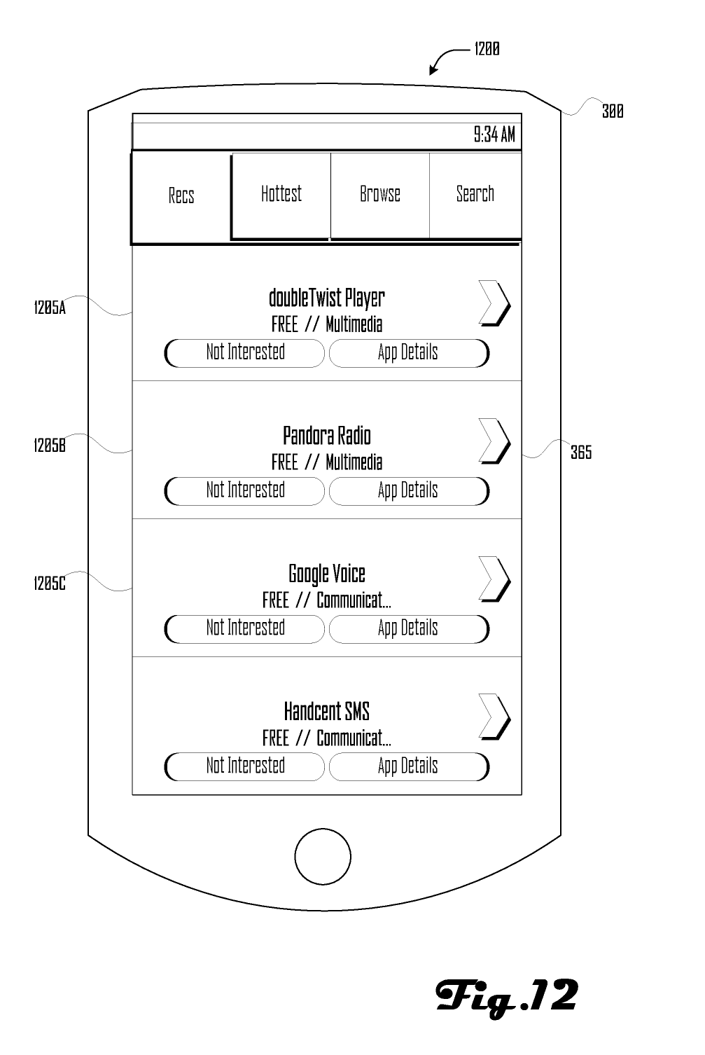

FIG. 12 illustrates an exemplary application-recommendation application 365 displaying on mobile application device 300 a list of recommended applications in accordance with one embodiment. Each recommended application includes a control 1205A-C by which a user can indicate that he or she is not interested in the application.

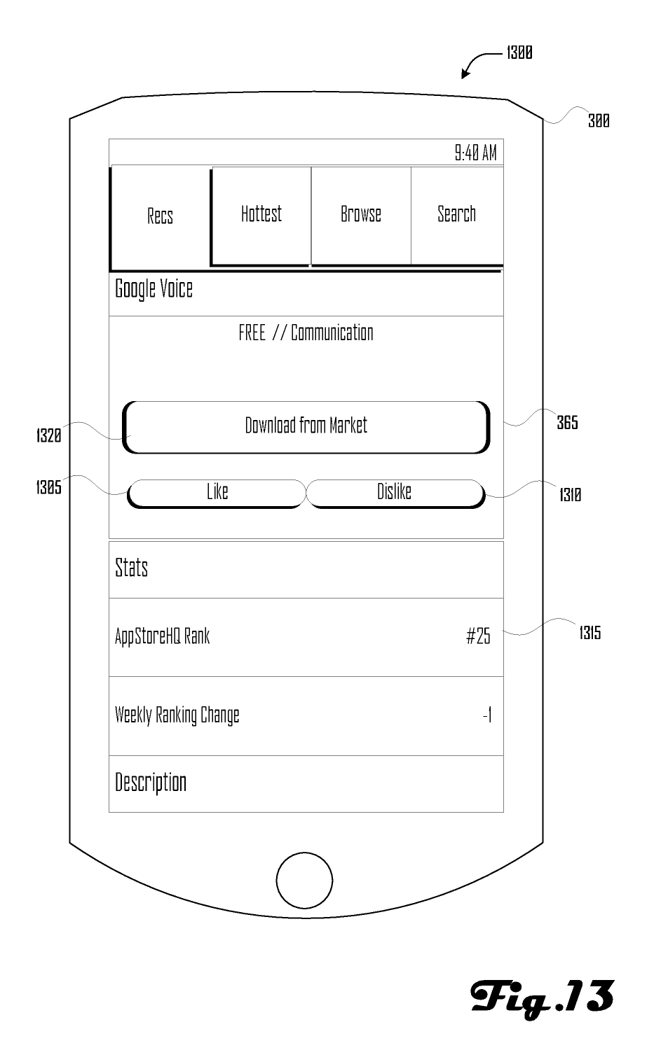

FIG. 13 illustrates an exemplary application-recommendation application 365 displaying on mobile application device 300 details for a recommended application in accordance with one embodiment. The detail display includes controls 1305-1310 by which a user can indicate that he or she likes or dislikes the application, as well as a control 1320 by which a user can obtain the recommended application from an application store. The detail display also shown a current hotness score 1315 for the application.

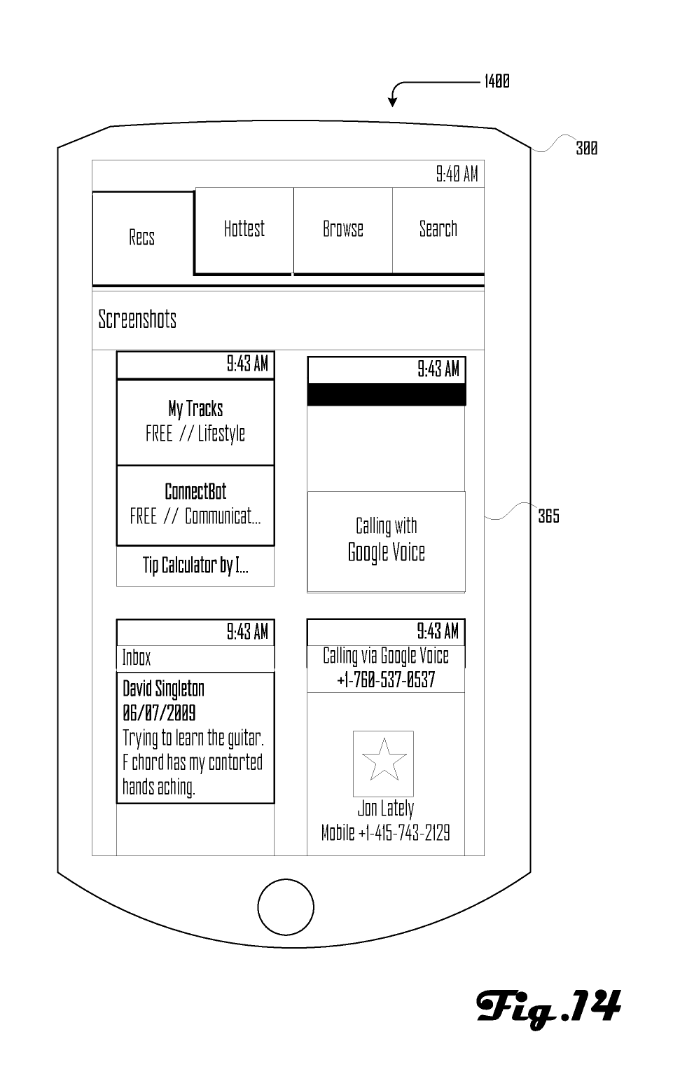

FIG. 14 illustrates an exemplary application-recommendation application 365 displaying on mobile application device 300 screen shots for a recommended application in accordance with one embodiment.

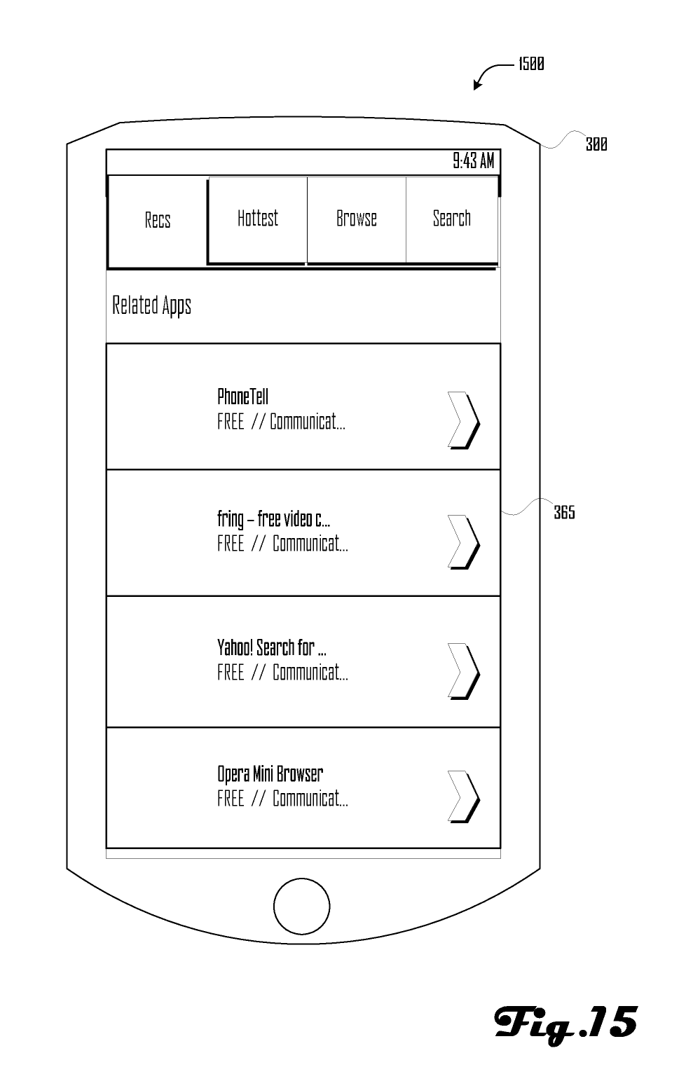

FIG. 15 illustrates an exemplary application-recommendation application 365 displaying on mobile application device 300 a list of applications that are similar to (or neighbors of) a recommended application in accordance with one embodiment.

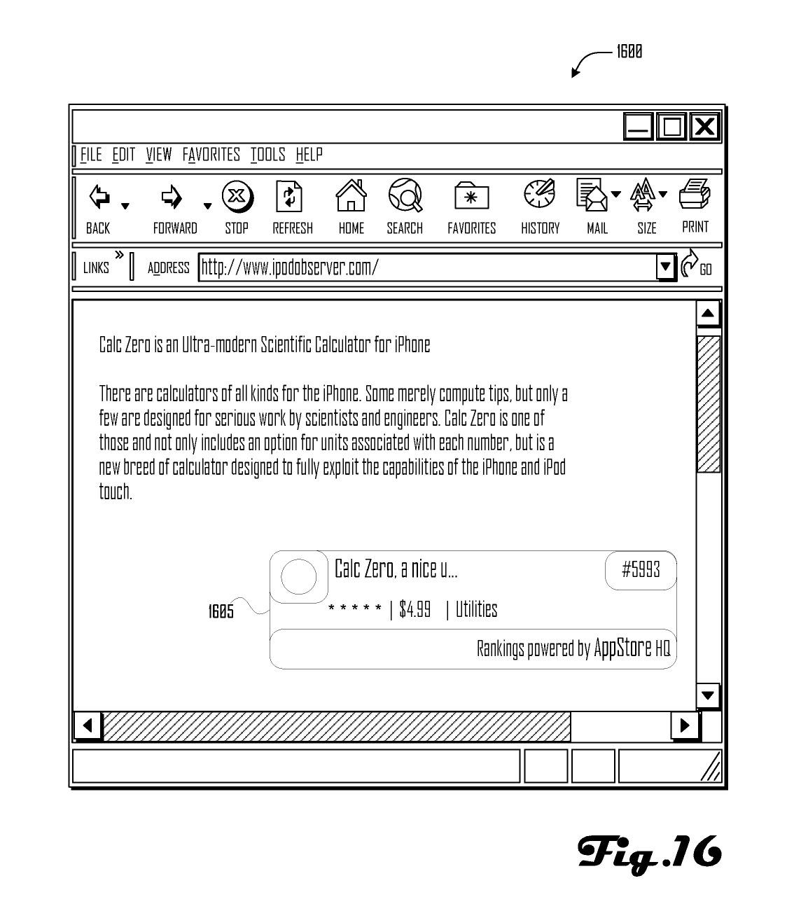

FIG. 16 illustrates a mention-tracking widget 1605 embedded on a web page displayed in a web browser 1600 in accordance with one embodiment. In one embodiment, the widget may be embedded on the page by including an image sourced from recommendations server 200. E.g.: <img src=“http://www.appstorehq.com/calczero-36285/app_back/” />

Although specific embodiments have been illustrated and described herein, a variety of alternate and/or equivalent implementations may be substituted for the specific embodiments shown and described without departing from the scope of the present disclosure.

For example, while the present disclosure discusses building an adjacency matrix where each entry is how many users two applications have in common, in other embodiments, the opposite adjacency matrix (i.e., the adjacency matrix that maps users to users) may be utilized in addition to or in place of the application-application adjacency matrix. A user-user adjacency matrix may be calculated similar to calculating the above-discussed application-application adjacency matrix, but the roles of the user and application are reversed, such that each entry describes how similar two users are based on how many applications they have in common. In other words, a user-user adjacency matrix would essentially relate groups of users to other groups of users with the underlying connections being applications. In some embodiments, using such a user-to-user matrix may facilitate providing recommendations with an even greater degree of personalization, as applications could be recommended if they have been liked, mentioned, and/or installed by other users who have similar overall tastes in applications (as indicated by a high similarity score between the a requesting user and the other users).

This application is intended to cover any adaptations or variations of the embodiments discussed herein.

1. An application recommendation system and method, as shown and described.
